(19) United States
(12) Patent Application Publication
(10) Pub. No.: US 2026/0269326 A1
(43) Pub. Date: Sep. 10, 2026

(54) ELECTRODE ASSEMBLY AND BATTERY

(71) Applicant: Ningde Amperex Technology Limited, Ningde City (CN)

(72) Inventor: Wenwen Zhang, Ningde City (CN)

(73) Assignee: Ningde Amperex Technology Limited, Ningde City (CN)

(21) Appl. No.: 19/561,952

(22) Filed: Mar. 10, 2026

(30) Foreign Application Priority Data
Mar. 10, 2025 (CN) 202510278805.0

(51) Int. Cl. H01M 10/0587; H01M 4/02; H01M 4/133; H01M 4/134; H01M 4/38; H01M 4/587; H01M 4/70; H01M 10/0525

(52) U.S. Cl. CPC H01M 10/0587; H01M 4/133; H01M 4/134; H01M 4/386; H01M 4/587; H01M 4/70; H01M 10/0525; H01M 2004/021; H01M 2004/027; H01M 2004/028

(57) ABSTRACT

An electrode assembly includes a positive electrode plate, a negative electrode plate, and a separator disposed between the positive electrode plate and the negative electrode plate. The positive electrode plate, the negative electrode plate, and the separator are wound for multiple turns to form an electrode body. The electrode body includes a flat portion and corner portions provided at two opposite ends of the flat portion. The positive electrode plate has multiple first protrusions provided corresponding to the corner portions. Along a direction of the positive electrode plate, a height Hm (μm) of the first protrusions satisfies: 15≤Hm≤80. Based on a total weight of the negative electrode active material layer, a weight percentage A of the silicon material particles satisfies: 5≤A≤50, and an average particle diameter Da (μm) of the silicon material particles satisfies: 1≤Da≤30.

### CROSS REFERENCE TO RELATED APPLICATIONS

The present application claims priority to Chinese Patent Application No. 202510278805.0, filed on Mar. 10, 2025, the disclosure of which is hereby incorporated by reference in its entirety.

### TECHNICAL FIELD

This application relates to the technical field of batteries, and in particular, to an electrode assembly and a battery.

### BACKGROUND

At present, the gram capacity improvement of negative electrode graphite in the lithium battery industry is facing a bottleneck. For the energy density improvement of lithium-ion batteries, silicon-containing materials are currently a key research focus in the industry. The theoretical gram capacity of silicon is as high as 4200 mAh/g, which is 10 times that of graphite. Silicon-containing materials are currently ideal alternative materials for graphite. However, the biggest challenge currently faced by silicon-containing materials is the swelling problem during cycling. When silicon and Li⁺ form LiₓSi, the volume swelling is as high as 320%. The high volume swelling of silicon-containing materials may cause excessive extrusion at corners of a wound battery, resulting in inability of electrolyte to be transported to the battery corners, thereby causing purple spots and lithium precipitation at the corners, and sharp drop in cycling of the battery.

### SUMMARY

The inventor has found that swelling of silicon-containing materials easily leads to extrusion between layers of an electrode assembly, and especially during charge and discharge of the battery, swelling and extrusion of the electrode assembly are further aggravated, resulting in insufficient electrolyte between the layers of the electrode assembly and poor infiltration, which easily leads to deterioration of the interface.

Embodiments of this application provide an electrode assembly and a battery, to alleviate swelling of silicon-containing materials, which easily leads to deterioration of an electrode plate interface.

In a first aspect, an embodiment of this application provides an electrode assembly. The electrode assembly includes a positive electrode plate, a negative electrode plate, and a separator disposed between the positive electrode plate and the negative electrode plate, where the positive electrode plate, the negative electrode plate, and the separator are wound for multiple turns to form an electrode body, and the electrode body includes a flat portion and corner portions provided at two opposite ends of the flat portion. The corner portions of the positive electrode plate are provided with multiple first protrusions, and along a thickness direction of the positive electrode plate, a height of the first protrusions is Hm (μm), where Hm satisfies: 15≤Hm≤80. The negative electrode plate includes a negative electrode active material layer, the negative electrode active material layer includes silicon material particles, and based on a total weight of the negative electrode active material layer, a weight percentage of the silicon material particles is A (%), where A satisfies: 5≤A≤50, and an average particle diameter Da (μm) of the silicon material particles satisfies: 1≤Da≤30. The silicon material particles in this application may be pure silicon particles or silicon-containing particles with a carbon material as a framework.

Based on the above embodiment, by matching the particle diameter Da of the silicon material particles of the negative electrode plate, the weight percentage A of the silicon material particles, and the height Hm of the first protrusions of the positive electrode plate, overall volume swelling of the negative electrode active material layer of the negative electrode plate exerts an appropriate force on the first protrusions of the positive electrode plate. The first protrusions have an appropriate support height, alleviating interface problems at the corner portions of the electrode assembly, thereby alleviating problems such as poor hipot test, poor K-value, overheating, and ignition of the battery.

In some embodiments, A satisfies: 5≤A≤20.

In some embodiments, the positive electrode plate includes a positive electrode current collector and a positive electrode active material layer provided on a surface of the positive electrode current collector, a coating weight per unit area of the positive electrode active material layer is CW1 (mg/1540.25 mm²), and CW1 satisfies: 150≤CW1≤400.

In some embodiments, CW1 satisfies: 150≤CW1≤250, and the negative electrode plate satisfies one of the following conditions:

$$10 < D a \leq 20 , 5 \leq A \leq 50 , and 15 \leq H m \leq 60 ; \qquad ( 1 )$$

$$5 < Da \leq 10 , 5 \leq A \leq 40 , and 17 \leq H m \leq 80 ; or \qquad ( 2 )$$

$$1 \leq Da \leq 5 , 5 \leq A \leq 23 , and 25 \leq H m \leq 80 . \qquad ( 3 )$$

In some embodiments, CW1 satisfies: 250≤CW1≤400, and the negative electrode plate satisfies one of the following conditions:

$$10 < D a \leq 20 , 5 \leq A \leq 50 , and 25 \leq H m \leq 70 ; \qquad ( 1 )$$

$$5 < Da \leq 10 , 5 \leq A \leq 40 , and 27 \leq H m \leq 80 ; or \qquad ( 2 )$$

$$1 \leq Da \leq 5 , 5 \leq A \leq 20 , and 35 \leq H m \leq 80 . \qquad ( 3 )$$

Based on the above embodiments, different CW1 of the positive electrode active material layer match different heights of the first protrusions are required, and the weight percentage A of the silicon material particles matches the average particle diameter Da of the silicon material particles in the negative electrode active material layer, to reduce damage to the positive electrode plate caused by swelling of the negative electrode active material layer, thereby optimizing a manufacturing process and safety of the battery.

In some embodiments, the silicon material particles are spherical silicon material particles.

In some embodiments, a sphericity of the silicon material particles is S, and S satisfies: 0.7≤S≤1.

Based on the above embodiments, the silicon material particles have a regular outer surface, which facilitates matching between the silicon material particles and the first protrusions of the positive electrode plate. When the silicon material particles swell, extrusion damage to the first protrusions is small, preventing the silicon material particles with a high hardness and overly sharp surface from piercing the separator or the positive electrode active material layer.

In some embodiments, the flat portion has a first thickness L1 in a first direction;
the two corner portions are respectively provided at two opposite ends of the flat portion in a second direction perpendicular to the first direction, and the corner portions have a second thickness L2 in the second direction;
each turn of the electrode plate includes two flat segments oppositely disposed along the first direction and two corner segments respectively provided at two ends of the flat segment along the second direction; and
the electrode plate has a tail end corresponding to a flat segment of an outermost turn of the electrode plate; all the flat segments and the tail end stacked in the first direction form the flat portion; the first thickness L1 is a thickness of the flat portion in the first direction, with the tail end counted; all the corner segments located on a same side of the flat segments in the second direction form the corner portion; the second thickness L2 is a thickness of the corner portion in the second direction passing through a midpoint of a line connecting two ends of an innermost corner segment; and the electrode assembly satisfies at least one of the following conditions:
(1) a winding turn number of the electrode plate of the electrode body is an even number, and L1 and L2 satisfy: 2.0≤L1/L2≤2.2; or
(2) a winding turn number of the electrode plate of the electrode body is an odd number, and L1 and L2 satisfy: 2.0≤L1/L2≤2.4.

Based on the above embodiments, the electrode assembly has appropriate internal stress, which can better buffer extrusion by the negative electrode active material layer on the separator and the positive electrode plate when the negative electrode active material layer swells, thereby reducing a probability of damage to the negative electrode active material layer, the positive electrode active material layer, and the separator. When the electrode assembly is used in a battery, safety of the battery in use is improved.

In some embodiments, the negative electrode active material layer includes a negative electrode active material, and the negative electrode active material includes the silicon material particles; and the negative electrode active material further includes at least one of silicon carbide, silicon oxide, graphite, or hard carbon.

In some embodiments, the negative electrode active material includes graphite, a gram capacity of graphite is ρ (mAh/g), ρ satisfies: 350≤ρ≤370 mAh/g, and an OI value of graphite satisfies: 6≤OI≤18.

Based on the above embodiments, for graphite with the OI value satisfying the above conditional range, irreversible swelling of graphite can be controlled within a reasonable range. Additionally, this avoids compromising the extension of the negative electrode plate in its length and width directions, facilitating processing protrusions on the negative electrode plate while reducing extrusion damage by the negative electrode plate to the positive electrode plate.

In some embodiments, the positive electrode plate includes the positive electrode active material layer, and the positive electrode active material layer includes
a positive electrode binder; and based on a total weight of the positive electrode active material layer, a weight percentage of the positive electrode binder is B, and 0.2%≤B≤2.4%.

Based on the above embodiments, the positive electrode binder exhibits a good binding effect, so that the positive electrode active material at the processed first protrusions has good morphological stability and is not prone to micro-cracks. Moreover, when the positive electrode active material is subjected to an extrusion force from the negative electrode active material layer caused by swelling, the positive electrode active material layer can still maintain good stability and is not easily deformed under extrusion or shed powder.

In a second aspect, an embodiment of this application provides a battery, including an outer packaging and the electrode assembly as described above, where the electrode assembly is provided in an internal space of the outer packaging.

Based on the electrode assembly and the battery according to the embodiments of this application, with silicon material particles having an appropriate content and an appropriate average particle diameter, the silicon material particles can reduce damage to the separator during battery preparation processes such as electrode plate winding, formation, and hot pressing. During embossing of the electrode plate, formation of protrusions on the electrode plate may lead to some micro-cracks. Silicon material particles are a relatively hard material. When a certain pressure is applied to the electrode assembly during the battery preparation process, micro-cracks generated on a surface of the positive electrode plate easily cause damage to the separator, and there is a risk that the silicon material pierces the separator. When the selected silicon material particles have an appropriate average particle diameter and an appropriate content, the silicon material particles on the negative electrode can effectively reduce micro-cracks, further reducing damage to the separator. In addition, when the selected silicon material particles are in a spherical shape, the silicon material particles can further reduce micro-cracks and damage to the separator. Since the silicon material particles swell, the silicon material particles in the negative electrode active material swell, which causes extrusion on the positive electrode plate. This especially has a greater impact on the first protrusions of the positive electrode plate. Main factors in irreversible swelling of the silicon material particles are the average particle diameter Da of the silicon material particles and a content of the silicon material particles. At the same content, a larger average particle diameter Da indicates a smaller irreversible swelling over cycles; at the same average particle diameter Da, a larger content of the silicon material particles indicates larger irreversible swelling over cycles. In addition, if the height Hm of the first protrusions of the positive electrode plate is excessively large, gaps between electrode plates are large during cycling, easily leading to purple spots and ion transport blocking in a later stage of cycling; if Hm is excessively small, an electrolyte cannot be replenished due to extrusion at the corners caused by irreversible swelling during cycling, easily leading to lithium precipitation at the corners. In the embodiments of this application, by matching the average particle diameter Da of the silicon material particles of the negative electrode plate, the weight percentage A of the silicon material particles, and the height Hm of the first protrusions of the positive electrode plate, overall volume swelling of the negative electrode active material layer of the negative electrode plate exerts an appropriate force on the first protrusions of the positive electrode plate. The first protrusions have a larger support height, alleviating interface problems at the corner portions of the electrode assembly, thereby alleviating problems such as poor hipot test, poor K-value, overheating, and ignition of the battery.

In addition, ion transport at the corners is also affected by the coating weight CW1 of the positive electrode active material layer of the positive electrode plate. A larger coating weight CW1 indicates more ion transport per unit area, requiring more timely electrolyte replenishment and a larger protrusion height Hm. The coating weight CW1 of the positive electrode plate is further set, so that overall volume swelling of the negative electrode active material layer of the negative electrode plate exerts an appropriate force on the first protrusions of the positive electrode plate, further alleviating interface problems at the corner portions of the electrode assembly and improving problems such as poor hipot test, poor K-value, overheating, and ignition of the battery.

### BRIEF DESCRIPTION OF DRAWINGS

To more clearly illustrate the embodiments of this application or the technical solutions in the prior art, the drawings used in the description of the embodiments or the prior art are briefly introduced below. It is clear that the drawings in the following description are only some embodiments of this application. For those skilled in the art, other drawings can also be obtained according to these drawings without creative efforts.

FIG. 1 is a schematic front view of a structure of an electrode plate in an unfolded state according to an embodiment of this application;

FIG. 2 is a schematic cross-sectional view of a structure of an electrode assembly according to an embodiment of this application; and

FIG. 3 is a schematic cross-sectional view of a partial structure of an electrode plate having protrusions according to an embodiment of this application.

Reference signs:
20: electrode body; 201: flat portion; 202: corner portion;
21: flat segment; 22: corner segment; 50: separator;
300: electrode plate; 311: protrusion; 311a: first protrusion;
410: positive electrode plate; 420: negative electrode plate;
X: length direction; Y: width direction; and Z: thickness direction.

### DETAILED DESCRIPTION

To make the objectives, technical solutions, and advantages of this application clearer, this application is further described in detail below with reference to the drawings and embodiments. It should be understood that the specific embodiments described herein are only used to explain this application and are not used to limit this application.

The inventor has found that introducing protrusion structures into an electrode plate can provide support during winding of the electrode plate, increasing gaps between electrode plate layers, which can alleviate corner extrusion caused by swelling of a silicon-containing material. Forming protrusion structures on a silicon-containing electrode plate through mechanical pressing currently has the following problems: (1) mechanical pressing leads to increased shedding of electrode plate materials; (2) mechanical pressing leads to increased extension of a current collector of the electrode plate, even current collector cracks; (3) since silicon-containing materials with many sharp protrusions are hard, a separator can be easily pierced during winding and hot pressing; and when subjected to further compression during other battery processing steps, the laminated electrode plate with the protrusion structures easily leads to increased poor hipot test (dielectric withstand test), increased poor K-value, overheating, ignition, and other risks.

Based on this, embodiments of this application provide an electrode assembly and a battery. A structure of the electrode assembly is designed to effectively alleviate problems related to electrolyte infiltration and electrode plate interface caused by swelling of silicon-containing materials.

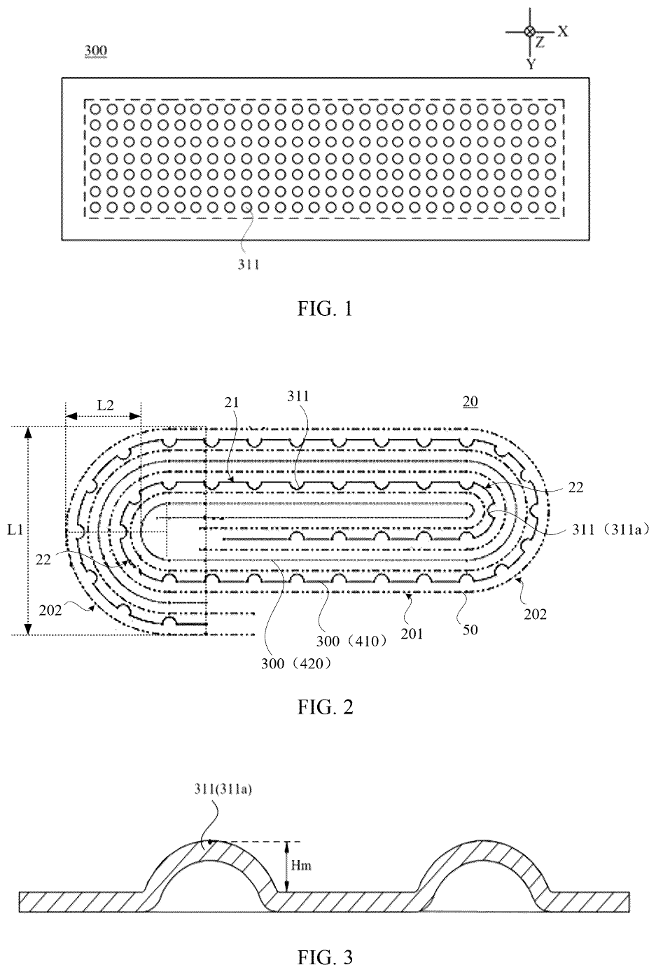

A battery provided in an embodiment of this application includes an outer packaging, an electrode assembly provided in an internal space of the outer packaging, and an electrolyte filling the internal space of the outer packaging. The electrode assembly includes two electrode plates with opposite polarities and a separator. As shown in FIG. 1, which is a schematic front view of a structure of an electrode plate 300 in an unfolded state according to an embodiment of this application, the electrode plate 300 has a length direction X, a width direction Y, and a thickness direction Z that are perpendicular to each other. Length directions X, width directions Y, and thickness directions Z of the two electrode plates 300 with opposite polarities of the electrode assembly are consistent. As shown in FIG. 2, a separator 50 is provided between the two electrode plates 300 with opposite polarities in the thickness direction Z of the electrode plate 300. One of the two electrode plates 300 with opposite polarities is a positive electrode plate 410 and the other is a negative electrode plate 420. The separator 50 is capable of insulation to separate the positive electrode plate 410 and the negative electrode plate 420 to prevent short circuit between the positive electrode plate 410 and the negative electrode plate 420. Silicon material particles in this application may be spherical silicon material particles with different sphericities (aspect ratios are different) or irregularly shaped silicon material particles. The silicon material particles in this application may be pure silicon particles or silicon-containing particles with a carbon material as a framework.

As shown in FIG. 2, the separator 50 and the two electrode plates 300 are wound for multiple turns along the length direction X of the electrode plate 300 to form an electrode body 20, where the length direction X of the electrode plate 300 is a winding direction of the electrode plate 300. The electrode body 20 is flat, and the electrode body 20 includes a flat portion 201 and two corner portions 202. The two corner portions 202 are respectively provided at two opposite ends of the flat portion 201. Specifically, each turn of the electrode plate 300 of the electrode body 20 includes two flat segments 21 and two corner segments 22. The two flat segments 21 are arranged side by side in a direction perpendicular to a plate surface of the flat segments 21, and the two corner segments 22 are oppositely disposed along a direction of the plate surface of the flat segments 21. That is, the two flat segments 21 and the two corner segments 22 are sequentially connected end to end. The electrode body 20 has a tail end, where the tail end is formed by a part of a flat segment 21 of an outermost turn of the electrode plate 300. All flat segments 21 stacked in the direction perpendicular to the plate surface of the flat segments 21, the tail end, and the separator 50 sandwiched between two adjacent flat segments 21 together form the flat portion 201. All corner segments 22 located on a same side of the flat segments 21 in the direction parallel to the plate surface of the flat segments 21 and the separator 50 sandwiched between two adjacent corner segments 22 together form the corner portion 202.

In the embodiments of this application, either of the two electrode plates (the positive electrode plate 410 and the negative electrode plate 420) may be provided with protrusions 311. Specifically, the electrode plate includes a current collector and an active material layer. The active material layer and the current collector are stacked along the thickness direction Z of the electrode plate 300, and the active material layer is provided on a surface of the current collector. The protrusions 311 are formed by a part of the current collector and a part of the active material layer protruding toward a same side of the electrode plate 300 along the thickness direction Z of the electrode plate 300. As shown in FIG. 1, the protrusions 311 are provided in a protrusion area on a surface of the active material layer facing away from the current collector, and there is a spacing between the protrusion area and an edge of the surface of the active material layer. After the two electrode plates 300 with opposite polarities and the separator 50 are wound for multiple turns to form the electrode body 20, the protrusions 311 contact the separator 50 and support for the separator 50. When the electrode body 20 swells, the protrusions 311 can still support the separator 50. A contact area between the protrusions 311 and the separator 50 is small, so that there is a space between a portion of the electrode plate 300 corresponding to the protrusion area 310 and the separator 50 to accommodate the electrolyte, preventing abnormalities such as insufficient electrolyte and poor infiltration between the electrode plate 300 and the separator 50 due to extrusion caused by swelling.

The electrode plate 300 has multiple protrusions 311, and at least one of the flat segment 21 and the corner segment 22 has the protrusions 311. Optionally, all the protrusions 311 provided on a single electrode plate 300 protrude toward a same side of the electrode plate 300 in the thickness direction Z of the electrode plate 300. For example, when both the flat segment 21 and the corner segment 22 have the protrusions 311, protrusions 311 provided on the flat segments 21 and protrusions 311 provided on the corner segments 22 all protrude toward a side of a winding center of the electrode body 20; or the protrusions 311 provided on the flat segments 21 and the protrusions 311 provided on the corner segments 22 all protrude toward a side facing away from the winding center of the electrode body 20. Optionally, some of the protrusions 311 provided on a single electrode plate 300 protrude toward a side of the electrode plate 300 in the thickness direction Z of the electrode plate 300, and the other protrusions 311 protrude toward another side of the electrode plate 300 in the thickness direction Z of the electrode plate 300. For example, the protrusions 311 provided on the flat segments 21 protrude toward a side of the winding center of the electrode body 20, and the protrusions 311 provided on the corner segments 22 protrude toward a side facing away from the winding center of the electrode body 20; or the protrusions 311 provided on the flat segments 21 protrude toward the side facing away from the winding center of the electrode body 20, and the protrusions 311 provided on the corner segments 22 protrude toward the side of the winding center of the electrode body 20.

The above descriptions are only exemplary, and orientations of the protrusions 311 of the electrode plates 300 are not limited in this application, which may be specifically determined according to actual needs.

A current collector of the positive electrode plate 410 is a positive electrode current collector, and an active material layer is a positive electrode active material layer. A current collector of the negative electrode plate 420 is a negative electrode current collector, and an active material layer is a negative electrode active material layer. The negative electrode active material layer includes a negative electrode active material, and the negative electrode active material includes a silicon-containing material. Swelling of the silicon-containing material easily causes damage to the negative electrode active material layer inside the negative electrode plate 420 due to internal stress, and easily causes extrusion on the separator 50 and the positive electrode plate 410. Especially when the positive electrode plate 410 has the protrusions 311, swelling of the silicon-containing material causes extrusion on the positive electrode plate 410, easily leading to deformation or damage at the protrusions 311. In addition, the positive electrode plate 410, the negative electrode plate 420, and the separator 50 are wound for multiple turns to form the electrode body. The electrode body includes a flat portion and corner portions provided at two opposite ends of the flat portion. When the positive electrode plate 410 is provided with protrusions 311 at the corresponding corner portion (that is, first protrusions 311a described later), since the protrusions 311 provided at the corresponding corner portion are already subjected to a large interlayer extrusion force, in a case where the silicon-containing material contained in the negative electrode active material layer swells, extrusion on the positive electrode plate 410 at the corner portion is further strengthened, causing the protrusions 311 of the positive electrode plate 410 at the corresponding corner portion to be more easily deformed under extrusion.

As shown in FIG. 2 and FIG. 3, the protrusions 311 of the positive electrode plate 410 include multiple first protrusions 311a provided at a corresponding corner portion. Along the thickness direction of the positive electrode plate 410, a height of the first protrusions 311a is Hm, where Hm satisfies: 15 μm≤Hm≤80 μm. In this height range, the first protrusions 311a can support the separator 50 and the negative electrode plate 420 at the corner portion, improving electrolyte infiltration. Preferably, 20 μm≤Hm≤55 μm. The silicon-containing material contained in the negative electrode active material is silicon material particles. Based on a total weight of the negative electrode active material layer, a weight percentage of the silicon material particles is A, where A satisfies: 1%≤A≤50%, preferably, 5%≤A≤20%. An average particle diameter Da of the silicon material particles satisfies: 1 μm≤Da≤30 μm, preferably, 5 μm≤Da≤20 μm.

In the embodiments of this application, using silicon material particles with an appropriate average particle diameter and an appropriate range can reduce damage to the separator 50 caused by swelling of the silicon material particles. A larger average particle diameter Da of the silicon material particles means a lower swelling rate of the silicon material particles and less extrusion at the corner portion caused by swelling of the silicon material particles. By matching the average particle diameter Da of the silicon material particles of the negative electrode plate 420, the weight percentage A of the silicon material particles, and the height Hm of the first protrusions 311a of the positive electrode plate 410, overall volume swelling of the negative electrode active material layer of the negative electrode plate 420 exerts an appropriate force on the first protrusions 311a of the positive electrode plate 410. Since the first protrusions 311a have a larger support height and good structural stability, they can stably provide support, alleviating interface problems at the corner portions of the electrode assembly, thereby alleviating problems such as poor hipot test, poor K-value, overheating, and ignition of the battery. When the selected silicon material particles are spherical, damage to the separator 50 can be further reduced, and a regular spherical shape and a smooth outer surface can provide support more stably, alleviating interface problems at the corner portion of the electrode assembly, thereby alleviating problems such as poor hipot test, poor K-value, overheating, and ignition of the battery.

In the embodiments of this application, the negative electrode plate 420 may also have protrusions 311. A part of the negative electrode current collector and a part of the negative electrode active material layer are extended and deformed for formation of the protrusions 311. When the negative electrode active material layer is extended, a particle diameter of the silicon material particles easily affects morphological stability of the negative electrode active material layer at the protrusions 311. For example, an excessively large particle diameter of the silicon material particles easily leads to risks such as micro-cracks or powder shedding of the negative electrode active material layer at the protrusions 311, affecting a yield rate during battery winding and battery safety. In addition, a content of the silicon material particles also greatly affects an overall volume swelling rate of the negative electrode active material layer. With the average particle diameter Da of the silicon material particles satisfying 1 μm≤Da≤30 m and a weight percentage A of the silicon material particles satisfying 5%≤A≤50%, the negative electrode plate 420 can be provided with protrusions 311 with better morphology, and then the negative electrode active material layer is not prone to abnormalities such as micro-cracks, powder shedding, or piercing of separator, improving a yield rate during winding. When the negative electrode plate 420 is used in a battery, safety of the battery in use is good. When A is greater than 50%, the content of the silicon material particles is excessively large, easily leading to an excessively high overall volume swelling rate of the negative electrode active material layer. When the average particle diameter Da of the silicon material particles is greater than 30 μm, the particle diameter of the silicon material particles is excessively large, this is not conducive to formation of the protrusions 311, and easily leads to risks such as micro-cracks or powder shedding of the negative electrode active material layer. In addition, a hardness of the silicon material particles is large, and when the silicon material particles swell, an excessively large average particle diameter Da of the silicon material particles more easily causes damage to the positive electrode plate 410 by extrusion.

In some embodiments, the positive electrode plate 410 includes a positive electrode current collector and a positive electrode active material layer provided on a surface of the positive electrode current collector. A coating weight per unit area of the positive electrode active material layer is CW1, where CW1 satisfies: 150 mg/1540.25 mm²≤CW1≤400 mg/1540.25 mm², for example, CW1 may be 150 mg/1540.25 mm², 200 mg/1540.25 mm², 300 mg/1540.25 mm², 350 mg/1540.25 mm², or 400 mg/1540.25 mm², or may be in any range therebetween. With the coating weight per unit area CW1 of the active material layer in the above range, the positive electrode plate 410 has an appropriate electrolyte infiltration effect, and this helps maintain a thickness of the positive electrode active material layer in an appropriate range. In this way, when the positive electrode plate 410 protrudes to form the first protrusions 311a, the positive electrode active material layer is not prone to micro-cracks, and the positive electrode active material layer is also not prone to abnormalities such as powder shedding and piercing of the separator 50.

It can be understood that for the positive electrode plate 410 with a relatively low CW1, a thickness of the positive electrode active material layer is relatively small, and for the positive electrode plate 410 with a relatively high CW1, a thickness of the positive electrode active material layer is relatively large. When the first protrusions 311a of the positive electrode plate 410 are generated, stress and plastic deformation occur on the positive electrode plate 410. In this case, the positive electrode plate 410 is extended. A larger height Hm of the first protrusions 311a means a larger extension rate thereof and greater damage to the positive electrode plate 410. In this case, micro-cracks are more easily generated on the surface of the positive electrode active material layer, posing risks such as powder shedding and piercing of the separator, affecting a yield rate during winding and battery safety. Moreover, when the positive electrode plate 410 is subjected to an extrusion force from the negative electrode active material layer caused by swelling, not only the first protrusions 311a of the positive electrode plate 410 are easily deformed, but also the positive electrode active material layer is easily damaged under extrusion if the thickness of the positive electrode active material layer does not match the content and the particle diameter of the silicon material particles. Therefore, different CW1 of the positive electrode active material layer match different heights of the first protrusions 311a, and the weight percentage A of the silicon material particles matches the average particle diameter Da of the silicon material particles in the negative electrode active material layer, to reduce damage to the positive electrode plate 410 caused by swelling of the negative electrode active material layer, thereby optimizing a manufacturing process and safety of the battery.

In some embodiments, CW1 satisfies: 150 mg/1540.25 mm²≤CW1≤250 mg/1540.25 mm², that is, when the coating weight per unit area CW1 of the positive electrode active material layer is relatively low, the negative electrode plate 420 satisfies one of the following conditions:

$$10 μm < D a \leq 20 μm , 5 \% \leq A \leq 50 \% , and 15 μm \leq H m \leq 60 μm ; \qquad ( 1 )$$

$$5 μm < Da \leq 10 μm , 5 \% \leq A \leq 40 \% , and 17 μm \leq H m \leq 80 μm ; or \qquad ( 2 )$$

$$1 μm \leq Da \leq 5 μm , 5 \% \leq A \leq 23 \% , and 25 μm \leq H m \leq 80 μm . \qquad ( 3 )$$

In some embodiments, CW1 satisfies: 250 mg/1540.25 mm²≤CW1≤400 mg/1540.25 mm², that is, when the coating weight per unit area CW1 of the positive electrode active material layer is relatively high, the negative electrode plate 420 satisfies one of the following conditions:

$$10 μm < D a \leq 20 μm , 5 \% \leq A \leq 50 \% , and 25 μm < H m \leq 70 μm ; \qquad ( 1 )$$

$$5 μm < Da \leq 10 μm , 5 \% \leq A \leq 40 \% , and 27 μm < H m \leq 80 μm ; or \qquad ( 2 )$$

$$1 μm \leq Da \leq 5 μm , 5 \% \leq A \leq 20 \% , and 35 μm \leq H m \leq 80 μm . \qquad ( 3 )$$

In this application, by introducing silicon material particles with the matching particle diameter of the silicon material particles and content of the silicon material particles in the negative electrode active material layer, for the positive electrode plate 410 having the first protrusions 311a, with the coating weight per unit area CW1 corresponding to the positive electrode active material layer, a more appropriate height of the first protrusions 311a can be achieved while reducing damage to the positive electrode plate 410, so that the positive electrode active material layer of the positive electrode plate 410 does not generate micro-cracks, and a processing process is not affected, thereby improving electrolyte infiltration and improving charge-discharge cycling performance of the battery without affecting safety performance at a battery level.

The positive electrode plate 410 has multiple second protrusions provided at the corresponding flat portion. Along the thickness direction of the positive electrode plate 410, a height of the second protrusions is Hn, an inner surface diameter of the first protrusions 311a is Rm, an inner surface diameter of the second protrusions is Rn, and the electrode assembly further satisfies at least one of the following conditions:

$$5 μm \leq Hn \leq 40 μm ; \qquad ( 1 )$$

$$1. 5 \leq Hm / Hn \leq 5 ; \qquad ( 2 )$$

$$0.3 mm \leq Rm \leq 10 mm ; or \qquad ( 3 )$$

$$Rm = Rn . \qquad ( 4 )$$

In some embodiments, a sphericity of the silicon material particles is S, satisfying: 0.7≤S≤1, for example, S may be 0.70, 0.74, 0.80, 0.88, 0.90, 0.96, or 1.0, or may be in any range therebetween. The sphericity of the silicon material particles is a ratio of a surface area of a sphere with a same volume as the silicon material particles to a surface area of the silicon material particles. In the embodiments of this application, with the sphericity of the silicon material particles satisfying the above conditional range, the silicon material particles have a regular outer surface, which facilitates matching between the silicon material particles and the first protrusions 311a of the positive electrode plate 410. When the silicon material particles swell, extrusion damage to the first protrusions 311a is small, preventing the silicon material particles with a high hardness and overly sharp surface from piercing the separator 50 or the positive electrode active material layer. Moreover, using silicon material particles with a relatively high sphericity S helps prevent micro-cracks in the negative electrode active material layer during processing of the protrusions 311 on the negative electrode plate 420. Therefore, comprehensively considering effects on the positive electrode plate 410 and the negative electrode plate 420, using the silicon material particles with the relatively high sphericity described above can effectively alleviate problems such as fast power loss of the battery and excessive voltage drop during long-term storage.

As shown in FIG. 2, the flat portion of the electrode body 20 has a first thickness L1 in a first direction; the two corner portions are respectively provided at the two opposite ends of the flat portion in a second direction perpendicular to the first direction, and the corner portions have a second thickness L2 in the second direction; each turn of the electrode plate includes two flat segments 21 oppositely disposed along the first direction and two corner segments 22 respectively provided at two ends of the flat segment 21 along the second direction; the electrode plate 300 has a tail end corresponding to the flat segment 21 of an outermost turn of the electrode plate 300; all the flat segments 21 and the tail end stacked in the first direction form the flat portion; the first thickness L1 is a thickness of the flat portion in the first direction, with the tail end counted; all the corner segments 22 located on a same side of the flat segments 21 in the second direction form the corner portion; and the second thickness L2 is a thickness of the corner portion in the second direction passing through a midpoint of a line connecting two ends of an innermost corner segment 22.

In some embodiments, the electrode assembly satisfies at least one of the following conditions:
(1) a winding turn number of the electrode plate of the electrode body is an even number, and L1 and L2 satisfy: 2.0≤L1/L2≤2.2; or
(2) a winding turn number of the electrode plate of the electrode body is an odd number, and L1 and L2 satisfy: 2.0≤L1/L2≤2.4.

With the first thickness L1 of the flat portion and the second thickness L2 of the corner portions satisfying the above conditional range, the electrode assembly has appropriate internal stress, which can better buffer extrusion by the negative electrode active material layer on the separator and the positive electrode plate 410 when the negative electrode active material layer swells, thereby reducing a probability of damage to the negative electrode active material layer, the positive electrode active material layer, and the separator. When the electrode assembly is used in a battery, safety of the battery in use is improved.

In the embodiments of this application, the negative electrode active material includes the silicon material particles, and the negative electrode active material may further include at least one of silicon carbide, silicon oxide, graphite, or hard carbon. Compared with other Si materials, spherical Si has optimal overall performance in cycling and swelling.

When the negative electrode active material includes graphite, graphite also undergoes certain volume swelling, but compared with the silicon material particles, a swelling rate of graphite is smaller, and a hardness of graphite is lower, so damage of graphite swelling to the separator and the positive electrode plate 410 is relatively small. In some embodiments, based on a total weight of the negative electrode active material layer, a weight percentage of graphite is C, where 50%≤C≤95%. This facilitates cooperation between graphite and the silicon material particles, so that while the battery has a higher energy density, the negative electrode active material layer has an appropriate swelling rate, reducing damage to the positive electrode plate 410 caused by the negative electrode active material layer.

In some embodiments, a gram capacity of graphite is ρ, where ρ satisfies: 350 mAh/g≤ρ≤370 mAh/g, for example, ρ may be 350 mAh/g, 355 mAh/g, 358 mAh/g, 362 mAh/g, 366 mAh/g, or 370 mAh/g, or may be in any range therebetween. Further providing the negative electrode active material with graphite in the above gram capacity range increases an energy density of the battery.

An OI value (On-Island value) of graphite reflects a lithium ion intercalation and deintercalation rate on a graphite surface and is an important basis for evaluating graphite performance. In some embodiments, the OI value of graphite satisfies: 6≤OI≤18, for example, the OI value may be 6, 7, 8, 9, 10, 11, 12, 14, 16, or 18, or may be in any range therebetween. For graphite with the OI value satisfying the above conditional range, irreversible swelling of graphite can be controlled within a reasonable range. Additionally, this avoids compromising the extension of the negative electrode plate 420 in its length and width directions, facilitating processing protrusions on the negative electrode plate 420 while reducing extrusion damage by the negative electrode plate 420 to the positive electrode plate 410.

The positive electrode active material layer includes a positive electrode active material. A type of the positive electrode active material is not limited in the embodiments of this application, and any material that can be used as a positive electrode active material in the art is applicable to this application. In some embodiments, the positive electrode active material includes at least one of a lithium cobalt oxide material LiCoO₂ (LCO), a ternary material, or a lithium iron phosphate material.

For example, the positive electrode active material includes LiCoO₂, LiNiO₂, LiMn₂O₄, LiCo_{1-y}M_{y}O₂, LiNi_{1-y}M_{y}O₂, LiMn_{2-y}M_{y}O₄, or LiNiₓCo_{y}Mn_{z}M_{1-x-y-z}O₂, where M is selected from at least one of Fe, Co, Ni, Mn, Mg, Cu, Zn, Al, Sn, B, Ga, Cr, Sr, V, or Ti, and 0≤y≤1, 0≤x≤1, 0≤z≤1, or x+y+z≤1.

The positive electrode active material layer further includes a positive electrode binder. The positive electrode binder and the positive electrode active material are mixed. The positive electrode binder binds the positive electrode active material, and the positive electrode binder located in an inner layer also binds the positive electrode current collector, so that the entire positive electrode active material can be stably attached to a surface of the positive electrode current collector. It can be understood that different contents of the positive electrode active material or different contents of the positive electrode binder result in different stress bearing capabilities and plastic deformation capabilities of the positive electrode plate 410. A higher content of the positive electrode active material means a lower content of the positive electrode binder, increasing the risk of powder shedding from the positive electrode active material layer during manufacture of the protrusions 311.

In some embodiments, based on a total weight of the positive electrode active material layer, a weight percentage of the positive electrode binder is B, where 0.2%≤B≤2.4%, for example, B may be 0.2%, 0.8%, 1.2%, 1.6%, 2.0%, 2.2%, or 2.4%, or may be in any range therebetween. With the content of the positive electrode binder in the above range, the positive electrode binder exhibits a good binding effect, so that the positive electrode active material at the processed first protrusions 311a has good morphological stability and is not prone to micro-cracks. Moreover, when the positive electrode active material is subjected to an extrusion force from the negative electrode active material layer caused by swelling, the positive electrode active material layer can still maintain good stability and is not easily deformed under extrusion or shed powder.

The positive electrode binder is not particularly limited in the embodiments of this application, and various materials known in the art that can be used as a positive electrode binder are applicable to this application. For example, the positive electrode binder may include at least one of a copolymer of vinylidene fluoride-hexafluoropropylene, a styrene-acrylate copolymer, a styrene-butadiene copolymer, polyamide, polyacrylonitrile, polyacrylate, polyacrylate salt, sodium carboxymethyl cellulose, polyvinyl acetate, polyvinylpyrrolidone, polyvinyl ether, polymethyl methacrylate, polytetrafluoroethylene, or polyhexafluoropropylene.

The positive electrode active material layer further includes a conductive agent. For example, the conductive agent in the positive electrode active material layer may include at least one of conductive carbon black, acetylene black, Ketjen black, flake graphite, graphene, carbon nanotubes, or carbon fibers.

The positive electrode current collector is not particularly limited in the embodiments of this application, and various materials known in the art that can be used as a positive electrode current collector are applicable to this application. For example, the positive electrode current collector may be aluminum foil. Certainly, other positive electrode current collectors commonly used in the art may also be used, and a thickness of the positive electrode current collector may be 1 μm to 200 μm. The positive electrode active material layer may be provided on one surface or two opposite surfaces of the positive electrode current collector. Further, in the thickness direction Z of the positive electrode plate 410, the positive electrode active material layer may be applied only to a part of the positive electrode current collector, and a thickness of the positive electrode active material layer may be 10 μm to 500 μm.

A material of the negative electrode current collector is not particularly limited in the embodiments of this application, and various materials known in the art that can be used as a negative electrode current collector are applicable to this application. For example, the negative electrode current collector may be at least one of copper foil, aluminum foil, nickel foil, or a carbon-based current collector; and a thickness of the negative electrode current collector may be 1 μm to 200 μm. The negative electrode active material layer may be provided on one surface or two opposite surfaces of the negative electrode current collector. Further, in the thickness direction Z of the negative electrode plate 420, the negative electrode active material layer may be applied only to a part of the negative electrode current collector. For example, a thickness of the negative electrode active material layer may be 10 μm to 500 μm.

The negative electrode active material layer may further include a conductive agent. For example, the conductive agent in the negative electrode active material layer may include at least one of carbon black, acetylene black, Ketjen black, graphene, carbon nanotubes, carbon fibers, or carbon nanowires. The negative electrode active material layer may further include a negative electrode binder, and the negative electrode binder may include at least one of carboxymethyl cellulose CMC, polyacrylate salt, polyacrylate, polyvinylpyrrolidone, polyaniline, polyimide, polyamideimide, polysiloxane, epoxy resin, polyester resin, polyurethane resin, or polyfluorene.

The separator 50 is not particularly limited in the embodiments of this application, and various materials known in the art that can be used as the separator 50 are applicable to this application. For example, the separator 50 includes at least one of polyethylene, polypropylene, polyvinylidene fluoride, polyethylene terephthalate, polyimide, or aramid. For example, polyethylene includes at least one of high-density polyethylene, low-density polyethylene, or ultra-high molecular weight polyethylene. Especially polyethylene and polypropylene can effectively prevent short circuit and can improve stability of the electrode assembly through a shutdown effect. A thickness of the separator 50 is in a range of about 3 μm to 500 μm.

The electrode assembly in the embodiments of this application further includes a positive electrode tab and a negative electrode tab. The positive electrode tab is provided on the positive electrode plate 410, and the negative electrode tab is provided on the negative electrode plate 420. The positive electrode tab and the negative electrode tab are not particularly limited in the embodiments of this application, and various materials known in the art that can be used as a positive electrode tab and a negative electrode tab are applicable to this application.

The electrolyte is not particularly limited in the embodiments of this application, and various materials known in the art that can be used as electrolyte are applicable to this application, and the electrolyte includes a lithium salt and a non-aqueous organic solvent.

For example, the lithium salt includes at least one of lithium hexafluorophosphate, lithium tetrafluoroborate, lithium bistrifluoromethanesulfonimide, lithium bisfluorosulfonimide, lithium nitrate, or lithium methylsulfite.

For example, the non-aqueous organic solvent may further include at least one of a carboxylate compound, an ether compound, or another organic solvent. The above carbonate compound may include but is not limited to at least one of a chain carbonate compound and a cyclic carbonate compound. The above chain carbonate compound may include but is not limited to at least one of dipropyl carbonate (DPC) or methyl ethyl carbonate (EMC). The above cyclic carbonate compound may include but is not limited to at least one of butylene carbonate (BC) or vinyl ethylene carbonate (VEC). The above carboxylate compound may include but is not limited to at least one of methyl formate, methyl acetate, ethyl acetate, n-propyl acetate, tert-butyl acetate, methyl propionate, ethyl propionate, or propyl propionate. The above ether compound may include but is not limited to at least one of dibutyl ether, tetraethylene glycol dimethyl ether, diethylene glycol dimethyl ether, 1,2-dimethoxyethane, 1,2-diethoxyethane, ethoxymethoxyethane, 2-methyltetrahydrofuran, or tetrahydrofuran. The another organic solvent may include but is not limited to at least one of dimethyl sulfoxide, 1,2-dioxolane, sulfolane, methyl sulfolane, 1,3-dimethyl-2-imidazolidone, N-methyl-2-pyrrolidone, formamide, dimethylformamide, trimethyl phosphate, triethyl phosphate, trioctyl phosphate, or phosphate ester. A mass percentage of the non-aqueous organic solvent in the electrolyte is not particularly limited in this application, as long as the objective of this application can be achieved. For example, based on a total mass of the electrolyte, a mass percentage of the non-aqueous organic solvent is 10% to 70%.

A packaging bag of the battery is not particularly limited in this application, which may be a packaging bag known in the art as long as the objective of this application can be achieved.

A type of the battery is not particularly limited in this application, which may include any apparatus in which electrochemical reactions occur. In this application, the battery may include but is not limited to: a lithium metal battery, a lithium-ion battery, a lithium polymer battery, a lithium-ion polymer battery, or the like.

A preparation process of the battery of this application is well known to those skilled in the art, and is not particularly limited in this application, for example, it may include but is not limited to the following steps: mounting the positive electrode tab on the positive electrode plate 410 and the negative electrode tab on the negative electrode plate 420; then stacking the positive electrode plate 410, the separator, and the negative electrode plate 420 in order; performing winding, folding, and the like as needed to obtain an electrode assembly with a wound structure; and placing the electrode assembly in a packaging bag, injecting the electrolyte into the packaging bag, and performing sealing to obtain a battery.

The battery provided in this application may be used in an electric apparatus, and a type of the electric apparatus is not particularly limited in this application, which may be any electric apparatus known in the prior art. In some embodiments, the electric apparatus may include but is not limited to: a notebook computer, a pen input computer, a mobile computer, an e-book player, a portable telephone, a portable fax machine, a portable copier, a portable printer, a stereo headset, a video recorder, a liquid crystal television, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a game console, a clock, a power tool, a flashlight, a camera, a large household battery, a lithium ion capacitor, and the like.

A lithium-ion battery is used as an example, and with reference to specific embodiments, this application is further described below. It should be understood that these embodiments are only used to illustrate this application and are not used to limit the scope of this application.

In the examples and comparative examples of this application, performance of the lithium-ion battery is tested by the following methods.

### (1) Test Method for Cycling Capacity Retention Rate at 25° C./45° C. For 5 C Charge/0.7 C Discharge

In an environment of 25° C./45° C., the lithium-ion battery was charged at a constant current of 5 C to a full charge voltage (a designed maximum voltage of the lithium-ion battery is 4.5V); then was charged at a constant maximum voltage to a current of 0.02 C; and then discharged at a constant discharge current of 0.7 C to a final voltage of 3.0V. A discharge capacity of the first cycle was recorded. Then the above steps were repeated for charge and discharge cycles, and a discharge capacity of the lithium-ion battery for each charge-discharge cycle was recorded, where cycling capacity retention rate at 25° C./45° C. for 5 C charge/0.7 C discharge=(discharge capacity of the Nth cycle/discharge capacity of the first cycle)×100%.

A cycle number corresponding to a cycling capacity less than or equal to 80% for 5 C at 25° C./45° C. was a charge-discharge cycle number corresponding to the cycling capacity retention rate of 80%.

### (2) Test Method for Electrolyte Retention Amount

During assembly of the lithium-ion battery, after drying in a vacuum oven at 85° C. for 12 h to remove moisture, a dry battery weight before electrolyte injection was recorded as w1; after processes such as vacuum packaging, standing, formation, capacity test, degassing, and edge cutting, a lithium-ion battery was obtained, and a weight of the lithium-ion battery was recorded as w2, where

$$electrolyte retention amount = ( w 2 - w 1 ) / w 1 \times 100 \% .$$

### (3) Test Method for Infiltration Improvement

An electrode plate was cut into a standard size of 10 mm×10 mm; 5 L of electrolyte was dropped on a surface of the electrode plate; a diffusion speed and an infiltration area of the electrolyte were observed; a contact angle of the electrolyte on the surface of the electrode plate was measured using a contact angle measuring instrument; and infiltration of the electrode plate was evaluated based on the diffusion speed and the contact angle of the electrolyte. A faster diffusion speed and a smaller contact angle indicated better infiltration.

A contact angle range of 0° to 30° indicated a “high” surface infiltration level; a contact angle range of 30° to 60° indicated a “medium” surface infiltration level; and a contact angle range of 60° to 90° indicated a “low” infiltration level.

### (4) Test Method for Active Material Layer Morphology

A positive electrode plate was cut into a standard size of 10 mm×10 mm and placed in a sample chamber of a scanning electron microscope (SEM), and a surface morphology of the electrode plate was observed using the scanning electron microscope (SEM).

If the surface of the positive electrode plate was smooth and complete without cracks, there was no powder shedding; if a quantity of pits per square centimeter on the surface of the positive electrode plate was less than or equal to 3, integrity of the positive electrode plate was damaged, indicating slight powder shedding; and if a quantity of pits per square centimeter on the surface of the positive electrode plate was greater than 3, the positive electrode plate was greatly damaged, indicating severe powder shedding.

### (5) Test Method for Average Particle Diameter Da of Silicon Material Particles

A captured SEM image (under backscattered electron mode to distinguish Si from graphite) of a second material layer was exported into a common image format (such as JPEG) for image processing and analysis with image analysis software (such as ImageJ). An image magnification was 5000×, 35 particles were tested, and a scale was calibrated: in the image analysis software, the image scale was calibrated based on the SEM magnification level. For example, if the magnification of the SEM was 10,000 times and 100 pixels in the image correspond to 1 micron, a size per pixel was 0.01 micron. Particles in the image were manually or automatically marked. A diameter or an equivalent diameter of each particle was measured (when the particle is irregular in shape, the equivalent diameter in this application is defined as a longest distance between two points of the particle), and size data of all particles were recorded, to calculate the average particle diameter Da in this application.

### (6) Test Method for Coating Weight Per Unit Area of Active Material Layer

An electrode plate of a certain area was cut into a disc with an area of 15.4025 cm² by a punching machine. A coating weight per unit area of the active material layer was obtained after deducting a weight of a current collector.

### (7) Test Method for Sphericity of Silicon Material Particles

The laser diffraction (Laser Diffraction) method was used to test a sphericity of spherical silicon material particles. The silicon material particles were dispersed in water to form a stable suspension; a laser light source was used to irradiate a sample, and scattered light intensities at multiple angles were collected by a detector; particle size distribution was calculated according to Mie scattering theory; and data was analyzed and fitted by software to generate a sphericity distribution map.

### (8) Test Method for Weight Percentage of Silicon Material Particles

The negative electrode plate was discharged at 0.1 C to 3.0V and processed to obtain the negative electrode plate; element distribution was determined by scanning electron microscope (SEM) test; a content of the silicon element was tested by energy dispersive X-ray spectroscopy analysis, with five places tested; and an average mass of the silicon element was calculated. A mass of the silicon material particles was twice the mass of the silicon element.

### (9) Test Method for Height Hm of Protrusions 311

The lithium-ion battery was charged at a constant current of 0.5 C to 4.5V; charged at a constant voltage of 4.5V to 0.05 C; left standing for 5 min; and then discharged at a constant current of 0.5 C to 3.0V. The lithium-ion battery was disassembled, and a positive electrode plate with a positive electrode material layer provided on a surface was taken out.

The positive electrode plates in examples and comparative examples underwent plasma longitudinal cutting along a thickness direction to obtain a flat cross-section; the cross-section was characterized using a Philips XL-30 field emission scanning electron microscope (SEM) with a magnification of 300 times; and a vertical height from a bottom to a top of protrusions was measured, where heights of five protrusions were measured and averaged to obtain Hm.

### (10) Test Method for Irreversible Swelling of Cell

For a fresh battery, a thickness at an Al tab position was measured using a micrometer, and three points were measured; and numerical values were recorded, with an average value recorded as TO. A cell was charged and discharged as follows: in a charge-discharge process, the cell was charged at 0.7 C to 4.5V and discharged at 0.5 C to 3V. Full charge thicknesses were measured every 50 cycles and at the end of cell cycling as described above. Thicknesses T1, T2, . . . , Tn were recorded, and a calculation formula of an irreversible swelling rate was: irreversible swelling rate=Tn/T0−1.

### (11) Test Method for K-Value

After cell production was completed, an open circuit voltage of the cell was first measured OCV1 using an open circuit voltage tester as; and after an interval of 48 h, the open circuit voltage of the cell was measured again as OCV2, where K-value=(OCV1−OCV2)mV/48 h. The K-value may characterize self-discharge performance of the cell. A larger K-value means a faster power loss speed of the battery, in other words, a faster power drop speed of the battery in a standing state. A smaller K-value means a slower power loss speed of the battery and good battery stability, in other words, a slower power drop speed of the battery in a standing state.

### Example 1-1

### (1) Preparation of Positive Electrode Plate

A positive electrode active material LiCoO₂, a positive electrode conductive agent conductive carbon black (Super P), and a positive electrode binder polyvinylidene fluoride (PVDF, Mw=7×10⁶) were mixed in a mass ratio of 96:2:2, with N-methylpyrrolidone (NMP) added as a solvent; and were uniformly stirred by a vacuum stirrer to obtain a positive electrode slurry with a solid content of 75 wt %. The positive electrode slurry was uniformly applied to one surface of a positive electrode current collector aluminum foil with a thickness of 10 m; dried at 85° C.; and cold pressed to obtain a positive electrode plate with one surface coated with a positive electrode active material layer with a thickness of 50 μm. Then, the above steps were repeated on another surface of the aluminum foil to obtain a positive electrode plate with two surfaces coated with the positive electrode active material layer. Then, a positive electrode plate with a specification of 74 mm×851 mm was obtained through cutting for later use.

A compacted density of the positive electrode active material layer was 4.23 g/cm³, and a coating weight per unit area CW1 of the positive electrode active material layer was 150 mg/1540.25 cm².

### (2) Preparation of Negative Electrode Plate

A negative electrode active material graphite, spherical silicon material particles of negative electrode active material (sphericity 0.8), a negative electrode conductive agent carbon nanotubes (CNT), a thickener carboxymethyl cellulose (CMC-Na, Mw=7×10⁵), and a negative electrode binder polyacrylamide (PAA, Polyacrylamide) were mixed in a mass ratio (0.285:0.665:0.05:0.05:4), with deionized water added as a solvent; and uniformly stirred by a vacuum stirrer to obtain a negative electrode slurry with a solid content of 50 wt %. The negative electrode slurry was uniformly applied to one surface of a negative electrode current collector copper foil with a thickness of 12 μm, dried at 85° C., and cold pressed to obtain a negative electrode plate with a single surface coated with a negative electrode active material layer with a thickness of 60 μm. Then, the above steps were repeated on another surface of the copper foil to obtain a negative electrode plate with two surfaces coated with the negative electrode active material layer. A negative electrode plate with a specification of 76 mm×867 mm was obtained through cutting for later use.

A compacted density of the negative electrode active material layer was 1.75 g/cm³; a weight percentage A of the silicon material particles was 30%; an average particle diameter Da of the silicon material particles was 20 m; and a sphericity S of the silicon material particles was 0.8.

### (3) Preparation of Separator

A polyethylene (PE) porous film with a thickness of 5 m was used.

### (4) Preparation of Electrolyte

In an argon atmosphere glove box with a water content less than 10 ppm, ethylene carbonate (EC), propylene carbonate (PC), and diethyl carbonate (DEC) were mixed in a mass ratio of 1:1:2 to obtain a base solvent; and then lithium hexafluorophosphate (LiPF₆) was dissolved in the above base solvent to obtain an electrolyte. Based on a total mass of the electrolyte, a mass percentage of LiPF₆ was 12.5%.

### (5) Assembly of Lithium-Ion Battery

An aluminum positive electrode tab was mounted in an edge area of the positive electrode plate 410 by rolling; a protective adhesive was attached to the edge area of the positive electrode plate 410; and a nickel negative electrode tab was mounted in an edge area of the negative electrode plate 420 by rolling.

The positive electrode plate 410 with the positive electrode tab, the separator 50, and the negative electrode plate 420 with the negative electrode tab were sequentially stacked, so that the separator 50 was located between the positive electrode plate 410 and the negative electrode plate 420 for isolation; and wound to obtain the electrode body 20. The electrode assembly was placed in an outer packaging aluminum plastic film, and then placed in a vacuum oven at 85° C. for drying for 12 h to remove moisture. Then the electrolyte was injected, and processes such as vacuum packaging, standing, formation (charge at a constant current of 0.2 C to 3.5V, and then charge at a constant current of 1 C to 3.9V), capacity test, degassing, and edge cutting were implemented to obtain a lithium-ion battery.

In Example 1-1, the positive electrode plate had protrusions 311. The protrusions 311 were obtained through rolling in a protrusion area of the positive electrode plate. The electrode plate 300 shown in FIG. 4 was used as the positive electrode plate, and was placed in the electrode body 20 during winding. Both corner segment 21 and flat segment 22 of each turn of the electrode plate 300 had protrusions 311, where a ratio of a height Hm of the first protrusions 311a to a height Hn of the second protrusions was: Hm/Hn=2.

In Examples 1-2 to 1-44, Example 1-46, and Comparative examples 1-1 to 1-9, parameters were the same as those in Example 1-1 except that in preparation of the positive electrode plate, the height of the first protrusions 311a and the coating weight per unit area CW1 of the positive electrode active material layer were adjusted as shown in Table 1, and in preparation of the negative electrode plate, the content A of the silicon material particles and the average particle diameter Da of the silicon material particles were adjusted as shown in Table 1.

In Example 1-45, no spherical silicon was contained, and based on a total mass of the negative electrode active material layer, a content of irregularly shaped silicon material particles was 30%, and other parameters were the same as in Example 1-1.

Parameters of the lithium-ion batteries in Examples 1-1 to 1-46 and Comparative examples 1-1 to 1-9 and performance test results of the lithium-ion batteries are shown in Table 1.

TABLE 1

| | Negative electrode plate | | | Positive electrode plate | | | | | |
|---|---|---|---|---|---|---|---|---|---|
| | | Average | | Coating weight | | | | | |
| | | particle | Total | per unit area | | Cycle number | Cycle number | | |
| | | diameter | content of | CW1 of | | corresponding | corresponding | | |
| | Percentage | Da of | negative | positive | | to cycling | to cycling | | |
| | A of silicon | silicon | electrode | electrode active | Height Hm | capacity less | capacity less | Electrolyte | |
| | material | material | active | material layer | of first | than or equal to | than or equal | retention | |
| | particles | particles | material | (mg/1540.25 | protrusions | 80% for 5 C at | to 80% for 5 C | amount | Infiltration |
| | (%) | (μm) | (%) | cm²) | (μm) | 25° C. | at 45° C. | (g/Ah) | improvement |
| Example 1-1 | 30 | 15 | 95.0 | 150 | 40.0 | 800 | 600 | 1.30 | High |
| Example 1-2 | 30 | 15 | 95.0 | 250 | 40.0 | 872 | 705 | 1.25 | Medium |
| Example 1-3 | 30 | 15 | 95.0 | 400 | 40.0 | 556 | 397 | 1.30 | Low |
| Example 1-4 | 30 | 8 | 95.0 | 200 | 40.0 | 610 | 405 | 1.26 | Medium |
| Example 1-5 | 30 | 10 | 95.0 | 200 | 40.0 | 712 | 506 | 1.28 | Medium |
| Example 1-6 | 30 | 15 | 95.0 | 200 | 40.0 | 803 | 603 | 1.30 | High |
| Example 1-7 | 30 | 20 | 95.0 | 200 | 40.0 | 862 | 651 | 1.30 | High |
| Example 1-8 | 30 | 23 | 95.0 | 200 | 40.0 | 584 | 403 | 1.30 | High |
| Example 1-9 | 5 | 15 | 97.8 | 200 | 40.0 | 809 | 652 | 1.32 | High |
| Example 1-10 | 10 | 15 | 97.8 | 200 | 40.0 | 811 | 609 | 1.31 | High |
| Example 1-11 | 20 | 15 | 97.5 | 200 | 40.0 | 812 | 649 | 1.30 | High |
| Example 1-12 | 40 | 15 | 95.0 | 200 | 40.0 | 707 | 508 | 1.24 | Medium |
| Example 1-13 | 50 | 15 | 94.5 | 200 | 40.0 | 605 | 403 | 1.22 | Medium |
| Comparative | 2 | 15 | 97.8 | 200 | 12.0 | 303 | 244 | 1.19 | Low |
| example 1-1 | | | | | | | | | |
| Comparative | 60 | 15 | 94.5 | 200 | 80.0 | 321 | 213 | 1.18 | Low |
| example 1-2 | | | | | | | | | |
| Example 1-14 | 30 | 15 | 95.0 | 120 | 40.0 | 505 | 407 | 1.30 | High |
| Example 1-15 | 30 | 15 | 95.0 | 430 | 40.0 | 482 | 443 | 1.19 | Low |
| Example 1-16 | 30 | 8 | 95.0 | 150 | 55.0 | 890 | 650 | 1.30 | High |
| Example 1-17 | 30 | 8 | 95.0 | 250 | 55.0 | 755 | 540 | 1.27 | Medium |
| Example 1-18 | 30 | 8 | 95.0 | 300 | 55.0 | 656 | 491 | 1.21 | Medium |
| Example 1-19 | 30 | 3 | 95.0 | 200 | 55.0 | 505 | 209 | 1.27 | High |
| Example 1-20 | 30 | 5 | 95.0 | 200 | 55.0 | 604 | 406 | 1.28 | High |
| Example 1-21 | 30 | 8 | 95.0 | 200 | 55.0 | 667 | 485 | 1.31 | High |
| Example 1-22 | 30 | 10 | 95.0 | 200 | 55.0 | 705 | 604 | 1.30 | High |
| Example 1-23 | 30 | 11 | 95.0 | 200 | 55.0 | 648 | 598 | 1.28 | High |
| Example 1-24 | 5 | 8 | 97.8 | 200 | 17.5 | 800 | 630 | 1.32 | High |
| Example 1-25 | 10 | 8 | 97.8 | 200 | 25.0 | 746 | 613 | 1.27 | High |
| Example 1-26 | 20 | 8 | 97.5 | 200 | 40.0 | 706 | 622 | 1.25 | Medium |
| Example 1-27 | 30 | 8 | 94.5 | 200 | 80.0 | 507 | 401 | 1.24 | Medium |
| Comparative | 35 | 8 | 94.5 | 200 | 85.0 | 244 | 145 | 1.18 | Low |
| example 1-3 | | | | | | | | | |
| Example 1-28 | 30 | 8 | 95.0 | 200 | 50.0 | 653 | 508 | 1.30 | High |
| Example 1-29 | 20 | 3 | 97.5 | 150 | 70.0 | 508 | 455 | 1.25 | Medium |
| Example 1-30 | 20 | 3 | 97.5 | 250 | 70.0 | 512 | 456 | 1.24 | Medium |
| Example 1-31 | 20 | 3 | 97.5 | 300 | 70.0 | 455 | 402 | 1.18 | Low |
| Example 1-32 | 20 | 1 | 97.5 | 200 | 70.0 | 502 | 423 | 1.22 | Medium |
| Example 1-33 | 20 | 3 | 97.5 | 200 | 70.0 | 515 | 465 | 1.24 | Medium |
| Example 1-34 | 20 | 5 | 97.5 | 200 | 70.0 | 576 | 486 | 1.26 | Medium |
| Example 1-35 | 45 | 6 | 97.5 | 200 | 70.0 | 498 | 410 | 1.20 | Medium |
| Example 1-36 | 5 | 3 | 97.8 | 200 | 25.0 | 558 | 415 | 1.25 | Medium |
| Example 1-37 | 10 | 3 | 97.8 | 200 | 40.0 | 576 | 433 | 1.27 | Medium |
| Example 1-38 | 20 | 3 | 97.5 | 200 | 70.0 | 615 | 457 | 1.26 | Medium |
| Example 1-39 | 23 | 3 | 97.3 | 200 | 79.0 | 517 | 408 | 1.23 | Medium |
| Example 1-40 | 25 | 3 | 97.3 | 200 | 85.0 | 445 | 365 | 1.19 | Low |
| Example 1-41 | 30 | 30 | 95.0 | 200 | 40.0 | 432 | 318 | 1.30 | High |
| Comparative | 30 | 35 | 95.0 | 200 | 40.0 | 250 | 150 | 1.31 | High |
| example 1-4 | | | | | | | | | |
| Example 1-41 | 30 | 15 | 95.0 | 200 | 15.0 | 618 | 507 | 1.25 | Medium |
| Example 1-42 | 30 | 15 | 95.0 | 200 | 20.0 | 734 | 602 | 1.27 | Medium |
| Example 1-43 | 30 | 15 | 95.0 | 200 | 40.0 | 800 | 656 | 1.32 | High |
| Example 1-44 | 30 | 15 | 95.0 | 200 | 80.0 | 562 | 463 | 1.32 | High |
| Comparative | 30 | 15 | 95.0 | 200 | 85.0 | 355 | 302 | 1.20 | Medium |
| example 1-5 | | | | | | | | | |
| Comparative | 30 | 15 | 95.0 | 200 | 10.0 | 314 | 301 | 1.16 | Low |
| example 1-6 | | | | | | | | | |
| Comparative | 60 | 35 | 95.0 | 200 | 85 | 255 | 221 | 1.10 | Low |
| example 1-7 | | | | | | | | | |
| Comparative | 60 | 15 | 95.0 | 200 | 85 | 286 | 267 | 1.14 | Low |
| example 1-8 | | | | | | | | | |
| Comparative | 30 | 35 | 95.0 | 200 | 85 | 278 | 271 | 1.13 | Low |
| example 1-9 | | | | | | | | | |
| Example 1-45 | / | 15 | 95.0 | 200 | 40 | 745 | 513 | 1.21 | Medium |
| Example 1-46 | 30 | 15 | 97.8 | 200 | 40.0 | 781 | 555 | 1.27 | Medium |

It can be learned from Examples 1-1 to 1-46 and Comparative examples 1-1 to 1-9 in Table 1 that, when the coating weight per unit area CW1 of the positive electrode active material layer satisfies 150 mg/1540.25 mm²≤CW1≤250 mg/1540.25 mm², the height Hm of the first protrusions of the positive electrode plate satisfies 5 μm≤Hm≤80 μm, the weight percentage A of silicon material particles in the negative electrode plate satisfies 0%≤A≤50%, and the average particle diameter Da of the silicon material particles satisfies 1 μm≤Da≤20 μm. In this case, the lithium-ion battery exhibits good overall performance. When A>50%, the charge-discharge cycling performance of the lithium-ion battery decreases significantly. This is because excessively high silicon content leads to large swelling during cycling, severe compression at the corners, and inability of the electrolyte to refill in time during cycling, resulting in electrolyte deficiency. In addition, due to the limited tensile property of the aluminum foil of the cathode, Hm cannot be further increased. When the average particle diameter Da of the silicon material particles exceeds 20 μm, the particles are excessively large, resulting in poor kinetics and consequently poor charge-discharge cycling performance of the battery.

Furthermore, it can be learned from Examples 1-1 to 1-15 and Examples 1-41 to 1-43 in Table 1 that, when the average particle diameter Da of the silicon material particles satisfies 10 μm≤Da≤20 μm, the weight percentage A of the silicon material particles satisfies 5%≤A≤50%, and the height Hm of the first protrusions 311a of the positive electrode plate 410 satisfies 15 km K Hm K 60 km. In this case, the lithium-ion battery exhibits good overall performance. Preferably, as can be learned from Examples 1-6 to 1-12, when the weight percentage A of the silicon material particles satisfies 30%≤A≤50%, the improvement in electrolyte infiltration is even better. This is because as the silicon content increases, compression at the corners becomes more severe, Hm becomes larger, the interlayer gap at the corners becomes larger, and the improvement at the corners during cycling is greater.

It can be learned from Examples 1-16 to 1-27 in Table 1 that, when the average particle diameter Da of the silicon material particles satisfies 5 μm<Da≤10 μm, the weight percentage A of the silicon material particles satisfies 5%≤A≤40%, and the height Hm of the first protrusions 311a of the positive electrode plate 410 satisfies 17 μm≤Hm≤80 km. In this case, the lithium-ion battery exhibits good overall performance.

It can be learned from Examples 1-29 to 1-46 in Table 1 that, when the average particle diameter Da of the silicon material particles satisfies 1 m≤Da≤5 μm, the weight percentage A of the silicon material particles satisfies 5%≤A≤23%, and the height Hm of the first protrusions 311a of the positive electrode plate 410 satisfies 25 μm≤Hm≤80 μm. In this case, the lithium-ion battery exhibits good overall performance.

In Examples 2-1 to 2-38 and Comparative examples 2-1 to 2-5, the parameters are the same as in Example 2-1 except that in preparation of the positive electrode plate, the height of the first protrusions 311a and the coating weight per unit area CW1 of the positive electrode active material layer were adjusted as shown in Table 2, and in preparation of the negative electrode plate, the content A of the silicon material particles and the average particle diameter Da of the silicon material particles were adjusted as shown in Table 2.

Parameters of the lithium-ion batteries in Examples 2-1 to 2-38 and Comparative examples 2-1 to 2-5 and performance test results of the lithium-ion batteries are shown in Table 2.

TABLE 2

| | Negative electrode plate | | | Positive electrode plate | | | | | |
|---|---|---|---|---|---|---|---|---|---|
| | | Average | | Coating weight | | | | | |
| | | particle | Total | per unit area | | Cycle number | Cycle number | | |
| | | diameter | content of | CW1 of | | corresponding | corresponding | | |
| | Percentage | Da of | negative | positive | | to cycling | to cycling | | |
| | A of silicon | silicon | electrode | electrode active | Height Hm | capacity less | capacity less | Electrolyte | |
| | material | material | active | material layer | of first | than or equal to | than or equal | retention | |
| | particles | particles | material | (mg/1540.25 | protrusions | 80% for 5 C at | to 80% for 5 C | amount | Infiltration |
| | (%) | (μm) | (%) | cm²) | (μm) | 25° C. | at 45° C. | (g/Ah) | improvement |
| Example 2-1 | 30 | 15 | 95.0 | 280 | 50.0 | 815 | 655 | 1.30 | High |
| Example 2-2 | 30 | 15 | 95.0 | 350 | 50.0 | 756 | 634 | 1.27 | Medium |
| Example 2-3 | 30 | 15 | 95.0 | 400 | 50.0 | 715 | 547 | 1.25 | Medium |
| Example 2-4 | 30 | 8 | 95.0 | 320 | 50.0 | 615 | 423 | 1.25 | Medium |
| Example 2-5 | 30 | 10 | 95.0 | 320 | 50.0 | 716 | 520 | 1.28 | Medium |
| Example 2-6 | 30 | 15 | 95.0 | 320 | 50.0 | 802 | 598 | 1.30 | High |
| Example 2-7 | 30 | 20 | 95.0 | 320 | 50.0 | 811 | 589 | 1.32 | High |
| Example 2-8 | 30 | 23 | 95.0 | 320 | 50.0 | 545 | 454 | 1.30 | High |
| Example 2-9 | 5 | 15 | 97.8 | 320 | 15.0 | 518 | 309 | 1.30 | High |
| Example 2-10 | 10 | 15 | 97.8 | 320 | 30.0 | 752 | 587 | 1.30 | High |
| Example 2-11 | 20 | 15 | 97.5 | 320 | 40.0 | 726 | 512 | 1.30 | High |
| Example 2-12 | 40 | 15 | 94.5 | 320 | 60.0 | 524 | 305 | 1.25 | Medium |
| Example 2-13 | 50 | 15 | 94.5 | 320 | 70.0 | 412 | 223 | 1.21 | Medium |
| Comparative | 2 | 15 | 97.8 | 320 | 22.0 | 356 | 254 | 1.16 | Low |
| example 2-1 | | | | | | | | | |
| Comparative | 60 | 15 | 94.5 | 320 | 80.0 | 287 | 257 | 1.25 | Medium |
| example 2-2 | | | | | | | | | |
| Example 2-14 | 30 | 15 | 95.0 | 420 | 50.0 | 530 | 408 | 1.30 | High |
| Example 2-15 | 30 | 8 | 95.0 | 280 | 65.0 | 712 | 511 | 1.30 | High |
| Example 2-16 | 30 | 8 | 95.0 | 350 | 65.0 | 635 | 487 | 1.24 | Medium |
| Example 2-17 | 30 | 8 | 95.0 | 400 | 65.0 | 555 | 433 | 1.22 | Medium |
| Example 2-18 | 30 | 3 | 95.0 | 320 | 65.0 | 513 | 301 | 1.23 | Medium |
| Example 2-19 | 30 | 5 | 95.0 | 320 | 65.0 | 603 | 405 | 1.24 | Medium |
| Example 2-20 | 30 | 8 | 95.0 | 320 | 65.0 | 707 | 412 | 1.27 | Medium |
| Example 2-21 | 30 | 10 | 95.0 | 320 | 65.0 | 766 | 611 | 1.30 | High |
| Example 2-22 | 30 | 11 | 95.0 | 320 | 65.0 | 809 | 657 | 1.30 | High |
| Example 2-23 | 5 | 8 | 97.8 | 320 | 27.5 | 765 | 658 | 1.25 | Medium |
| Example 2-24 | 10 | 8 | 97.8 | 320 | 35.0 | 655 | 545 | 1.25 | Medium |
| Example 2-25 | 20 | 8 | 97.5 | 320 | 50.0 | 651 | 510 | 1.24 | Medium |
| Example 2-26 | 30 | 8 | 94.5 | 320 | 80.0 | 555 | 466 | 1.21 | High |
| Comparative | 35 | 8 | 94.5 | 320 | 95.0 | 317 | 222 | 1.30 | High |
| example 2-3 | | | | | | | | | |
| Example 2-27 | 15 | 3 | 97.5 | 280 | 65.0 | 658 | 537 | 1.30 | High |
| Example 2-28 | 15 | 3 | 97.5 | 350 | 65.0 | 634 | 515 | 1.27 | Medium |
| Example 2-29 | 15 | 3 | 97.5 | 400 | 65.0 | 624 | 487 | 1.25 | Medium |
| Example 2-30 | 15 | 1 | 97.5 | 320 | 65.0 | 457 | 382 | 1.21 | Medium |
| Example 2-31 | 15 | 3 | 97.5 | 320 | 65.0 | 512 | 423 | 1.23 | Medium |
| Example 2-32 | 15 | 5 | 97.5 | 320 | 65.0 | 556 | 445 | 1.25 | Medium |
| Example 2-33 | 45 | 6 | 97.5 | 320 | 65.0 | 608 | 512 | 1.27 | Medium |
| Example 2-34 | 5 | 3 | 97.8 | 320 | 35.0 | 713 | 489 | 1.27 | Medium |
| Example 2-35 | 10 | 3 | 97.8 | 320 | 50.0 | 632 | 475 | 1.25 | Medium |
| Example 2-36 | 15 | 3 | 97.5 | 320 | 65.0 | 556 | 413 | 1.24 | Medium |
| Example 2-37 | 20 | 3 | 97.5 | 320 | 80.0 | 509 | 415 | 1.22 | Medium |
| Comparative | 22 | 3 | 97.5 | 320 | 86.0 | 220 | 185 | 1.18 | Low |
| example 2-4 | | | | | | | | | |
| Example 2-38 | 30 | 30 | 95.0 | 320 | 50.0 | 487 | 376 | 1.30 | High |
| Comparative | 30 | 35 | 95.0 | 200 | 40.0 | 255 | 156 | 1.31 | High |
| example 2-5 | | | | | | | | | |

It can be learned from Examples 2-1 to 2-38 and Comparative examples 2-1 to 2-5 in Table 2, similarly, when the coating weight per unit area CW1 of the positive electrode active material layer satisfies 250 mg/1540.25 mm²≤CW1≤400 mg/1540.25 mm², the height Hm of the first protrusions of the positive electrode plate satisfies 5 μm≤Hm≤80 μm, the weight percentage A of the silicon material particles of the negative electrode plate satisfies 0%≤A≤50%, and the average particle diameter Da of the silicon material particles satisfies 1 μm≤average particle diameter Da≤30 km. In this case, the lithium-ion battery exhibits good overall performance.

Furthermore, it can be learned from Examples 2-1 to 2-14 in Table 2, when the average particle diameter Da of the silicon material particles satisfies 10 μm<average particle diameter Da≤20 μm, the weight percentage A of the silicon material particles satisfies 5%≤A≤50%, and the height Hm of the first protrusions 311a of the positive electrode plate 410 satisfies 25 μm≤Hm≤70 km. In this case, the lithium-ion battery exhibits good overall performance.

It can be learned from Examples 2-15 to 2-26 in Table 2, when the average particle diameter Da of the silicon material particles satisfies 5 μm<average particle diameter Da≤10 μm, the weight percentage A of the silicon material particles satisfies 5%≤A≤40%, and the height Hm of the first protrusions 311a of the positive electrode plate 410 satisfies 27 μm≤Hm≤80 μm, the lithium-ion battery exhibits good overall performance.

It can be learned from Examples 2-27 to 2-38 in Table 2, when the average particle diameter Da of the silicon material particles satisfies 1 μm<average particle diameter Da≤5 μm, the weight percentage A of the silicon material particles satisfies 5%≤A≤20%, and the height Hm of the first protrusions 311a of the positive electrode plate 410 satisfies 35 μm≤Hm≤80 am. In this case, the lithium-ion battery exhibits good overall performance.

In Examples 3-1 to 3-20, the parameters are the same as in Example 1-7 except that in preparation of the negative electrode plate, other types of negative electrode active materials in addition to the silicon material particles were added as shown in Table 3.

Parameters of the lithium-ion batteries in Examples 3-1 to 3-20 and performance test results of the lithium-ion batteries are shown in Table 3.

In Example 3-21, irregular silicon carbide was used, and the parameters are the same as in Example 1-7.

TABLE 3

| | Negative electrode plate | | | | | | |
|---|---|---|---|---|---|---|---|
| | Other | | | | | | |
| | components of | | | | | | Cycle number |
| | negative | | | | | | corresponding |
| | electrode | | | Gram | Sphericity | | to cycling |
| | active material | | Gram | capacity | S of | Content B | capacity less |
| | besides silicon | Spherical | capacity ρ | OI | silicon | of positive | than or equal |
| | material | Si/graphite | of graphite | value of | material | electrode | to 80% for 5 C |
| | particles | ratio | (mAh/g) | graphite | particles | binder (%) | at 25° C. |
| Example 1-7 | Graphite | 3/7 | 360 | 12.0 | 0.8 | 1.2 | 800 |
| Example 3-1 | Graphite | 0/10 | 360 | 12.0 | / | 1.2 | 799 |
| Example 3-2 | Graphite | 3/7 | 380 | 12.0 | 0.8 | 1.2 | 554 |
| Example 3-3 | Graphite | 3/7 | 340 | 12.0 | 0.8 | 1.2 | 535 |
| Example 3-4 | Graphite | 3/7 | 350 | 12.0 | 0.8 | 1.2 | 789 |
| Example 3-5 | Graphite | 3/7 | 355 | 12.0 | 0.8 | 1.2 | 802 |
| Example 3-6 | Graphite | 3/7 | 370 | 12.0 | 0.8 | 1.2 | 685 |
| Example 3-7 | Graphite | 3/7 | 360 | 5.0 | 0.8 | 1.2 | 515 |
| Example 3-8 | Graphite | 3/7 | 360 | 6.0 | 0.8 | 1.2 | 633 |
| Example 3-9 | Graphite | 3/7 | 360 | 8.0 | 0.8 | 1.2 | 706 |
| Example 3-10 | Graphite | 3/7 | 360 | 12.0 | 0.8 | 1.2 | 803 |
| Example 3-11 | Graphite | 3/7 | 360 | 16.0 | 0.8 | 1.2 | 723 |
| Example 3-12 | Graphite | 3/7 | 360 | 18.0 | 0.8 | 1.2 | 687 |
| Example 3-13 | Graphite | 3/7 | 360 | 20.0 | 0.8 | 1.2 | 501 |
| Example 3-14 | Silicon oxide | 3/7 | / | / | 0.8 | 1.2 | 505 |
| Example 3-15 | Hard carbon | 3/7 | / | / | 0.8 | 1.2 | 505 |
| Example 3-16 | Graphite | 3/7 | 360 | 12.0 | 0.8 | 0.2 | 554 |
| Example 3-17 | Graphite | 3/7 | 360 | 12.0 | 0.8 | 1.5 | 706 |
| Example 3-18 | Graphite | 3/7 | 360 | 12.0 | 0.8 | 2.4 | 537 |
| Example 3-19 | Graphite | 3/7 | 360 | 12.0 | 0.8 | 2.7 | 453 |
| Example 3-20 | Graphite | 3/7 | 360 | 12.0 | 0.8 | 0.1 | 429 |
| Example 3-21 | Irregularly | 3/7 | 360 | 12.0 | 0.8 | 1.2 | 488 |
| | shaped silicon | | | | | | |
| | carbide | | | | | | |

| | | | Irreversible | | |
|---|---|---|---|---|---|
| | Cycle number | | swelling | | |
| | corresponding | | corresponding | | |
| | to cycling | | to cycling | | |
| | capacity less | Electrolyte | capacity less | | |
| | than or equal | retention | than or equal to | | Energy |
| | to 80% for 5 C | amount | 80% at 45° C. | Infiltration | density |
| | at 45° C. | (g/Ah) | (%) | improvement | (Wh/L) |
| Example 1-7 | 612 | 1.30 | 14.2 | High | 760 |
| Example 3-1 | 608 | 1.32 | 8.3 | High | 646 |
| Example 3-2 | 459 | 1.27 | 16.0 | Medium | 732 |
| Example 3-3 | 457 | 1.25 | 13.4 | Medium | 737 |
| Example 3-4 | 582 | 1.31 | 14.5 | High | 749 |
| Example 3-5 | 604 | 1.30 | 14.1 | High | 754 |
| Example 3-6 | 534 | 1.28 | 15.2 | High | 771 |
| Example 3-7 | 456 | 1.32 | 13.1 | High | 760 |
| Example 3-8 | 487 | 1.33 | 13.4 | High | 760 |
| Example 3-9 | 557 | 1.32 | 13.7 | High | 760 |
| Example 3-10 | 644 | 1.30 | 14.2 | Medium | 760 |
| Example 3-11 | 557 | 1.25 | 14.5 | Medium | 760 |
| Example 3-12 | 532 | 1.22 | 14.6 | Medium | 760 |
| Example 3-13 | 420 | 1.18 | 15.2 | Low | 760 |
| Example 3-14 | 405 | 1.25 | 17.9 | Medium | 755 |
| Example 3-15 | 403 | 1.30 | 11.5 | High | 700 |
| Example 3-16 | 456 | 1.24 | 14.5 | Medium | 763 |
| Example 3-17 | 612 | 1.30 | 13.3 | High | 759 |
| Example 3-18 | 486 | 1.30 | 12.5 | High | 755 |
| Example 3-19 | 431 | 1.30 | 12.2 | High | 754 |
| Example 3-20 | 406 | 1.22 | 15.6 | Medium | 763 |
| Example 3-21 | 387 | 1.20 | 17.9 | Medium | 750 |

It can be learned from Examples 3-1 to 3-6, when the gram capacity p of graphite satisfies 350 mAh/g≤ρ≤370 mAh/g, battery cycling and infiltration are greatly improved.

It can be learned from Examples 3-7 to 3-13, when the OI value of graphite satisfies 6≤OI≤18, the charge-discharge cycling performance of the battery can be greatly improved. A larger OI value indicates greater irreversible swelling of the cell, more severe extrusion at the corners, and poorer infiltration. A smaller OI value indicates smaller irreversible swelling of the cell, but poorer extension of the negative electrode plate in its width and length directions, which easily leads to deformation of the cell body after winding and formation, thereby easily causing deterioration of charge-discharge cycling performance of the battery.

It can be learned from Examples 3-14, 3-15, and 3-21 in Table 3, adding irregularly shaped silicon carbide or silicon oxide can increase the battery energy density, but overall performance is slightly inferior to that of spherical Si. This is mainly because silicon material particles have stronger ability to resist stress swelling during silicon cycling, which can further increase the battery energy density. Hard carbon can improve cell irreversible swelling, but capacity decays quickly during cycling.

It can be learned from Example 3-13 and Examples 3-16 to 3-20, when the content of the positive electrode binder satisfies 0.2%≤B≤2.4%, battery cycling is greatly improved. A lower binder content indicates poorer extension, increases difficulty in formation of corner gaps during processing, and leads to poorer infiltration and worse cycling. A higher binder content indicates better extension, and reduces difficulty in formation of the corner gaps, but when the binder content exceeds a certain range, cathode kinetics becomes poor and cycling deteriorates.

In Example 4-1 to 4-4, the parameters are the same as in Example 1-7 except that in preparation of the negative electrode plate, the sphericity of the silicon material particles was adjusted as shown in Table 4.

Parameters of the lithium-ion batteries in Examples 4-1 to 4-4 and performance test results of the lithium-ion batteries are shown in Table 4.

TABLE 4

| | Negative electrode plate | | | | | |
|---|---|---|---|---|---|---|
| | Other | | | | | |
| | components of | | | | | |
| | negative | | Gram | Gram | | Content B |
| | electrode active | | capacity | capacity | Sphericity | of positive |
| | material besides | Spherical | ρ of | OI value | S of silicon | electrode |
| | silicon material | Si/graphite | graphite | of | material | binder |
| | particles | ratio | (mAh/g) | graphite | particles | (%) |
| Example 1-7 | Graphite | 3/7 | 360 | 12.0 | 0.8 | 1.2 |
| Example 4-1 | Graphite | 3/7 | 360 | 12.0 | 0.5 | 1.2 |
| Example 4-2 | Graphite | 3/7 | 360 | 12.0 | 0.7 | 1.2 |
| Example 4-3 | Graphite | 3/7 | 360 | 12.0 | 0.9 | 1.2 |
| Example 4-4 | Graphite | 3/7 | 360 | 12.0 | 1.0 | 1.2 |

| | Cycle number | Cycle number | | | |
|---|---|---|---|---|---|
| | corresponding | corresponding | | | |
| | to cycling | to cycling | | | |
| | capacity less | capacity less | Electrolyte | | Cell K- |
| | than or equal to | than or equal to | retention | | value |
| | 80% for 5 C | 80% for 5 C | amount | Infiltration | pass rate |
| | at 25° C. | at 45° C. | (g/Ah) | improvement | (%) |
| Example 1-7 | 800 | 600 | 1.30 | High | 92% |
| Example 4-1 | 576 | 501 | 1.30 | High | 85% |
| Example 4-2 | 676 | 554 | 1.30 | High | 89% |
| Example 4-3 | 623 | 503 | 1.30 | High | 93% |
| Example 4-4 | 556 | 481 | 1.30 | High | 95% |

It can be seen from Examples 4-1 to 4-4, with the sphericity S of the silicon material particles satisfying 0.7≤S≤1, the silicon material particles have a regular outer surface, which prevents the silicon material particles from having high hardness and overly sharp surfaces that pierce the separator 50. Moreover, using silicon material particles with a higher sphericity S can effectively alleviate problems such as poor K-value of the battery, fast power loss, and excessive voltage drop during long-term storage. In addition, the electrolyte infiltration of the battery is better, improving cycling performance of the battery at room temperature and high temperature.

In the drawings of these embodiments, the same or similar reference signs correspond to the same or similar components; in the description of this application, it needs to be understood that if terms “upper”, “lower”, “left”, “right”, and the like indicate an orientation or positional relationship based on the orientation or positional relationship shown in the drawings, it is only for convenience of describing this application and simplifying the description, rather than indicating or implying that a referred apparatus or element must have a specific orientation, or be constructed and operated in a specific orientation. Therefore, terms describing the positional relationship in the drawings are only for exemplary illustration and cannot be understood as limitations on the present patent. For those of ordinary skill in the art, specific meanings of the above terms can be understood according to specific situations.

The above are only preferred embodiments of this application and are not intended to limit this application. Any modification, equivalent replacement, improvement, and the like made within the spirit and principle of this application shall be included in the protection scope of this application.

What is claimed is:

1. An electrode assembly, comprising a positive electrode plate, a negative electrode plate, and a separator disposed between the positive electrode plate and the negative electrode plate; wherein the positive electrode plate, the negative electrode plate, and the separator are wound for multiple turns to form the electrode assembly body, and the electrode body comprises a flat portion and corner portions provided at two opposite ends of the flat portion, the corner portions refer to the curved portions in the electrode body;
the corner portions of the positive electrode plate are provided with a plurality of first protrusions, and along a thickness direction of the positive electrode plate, a height of the first protrusions is Hm (μm), wherein 15≤Hm≤80; and
the negative electrode plate comprises a negative electrode active material layer, the negative electrode active material layer comprises silicon material particles; and based on a total weight of the negative electrode active material layer, a weight percentage of the silicon material particles is A (%), wherein 5≤A≤50; and an average particle diameter Da (μm) of the silicon material particles satisfies: 1≤Da≤30.

2. The electrode assembly according to claim 1, wherein 5≤A≤20.

3. The electrode assembly according to claim 1, wherein the positive electrode plate comprises a positive electrode current collector and a positive electrode active material layer provided on a surface of the positive electrode current collector, a coating weight per unit area of the positive electrode active material layer is CW1 (mg/1540.25 mm²), and 150≤CW1≤400.

4. The electrode assembly according to claim 3, wherein 150≤CW1≤250, and the negative electrode plate satisfies one of the following conditions:
$$10 < D a \leq 20 , 5 \leq A \leq 50 , and 15 \leq H m \leq 60 ; \qquad ( 1 )$$
$$5 < Da \leq 10 , 5 \leq A \leq 40 , and 17 \leq H m \leq 80 ; or \qquad ( 2 )$$
$$1 \leq Da \leq 5 , 5 \leq A \leq 23 , and 25 \leq H m \leq 80 . \qquad ( 3 )$$

5. The electrode assembly according to claim 3, wherein 250≤CW1≤400, and the negative electrode plate satisfies one of the following conditions:
$$10 < D a \leq 20 , 5 \leq A \leq 50 , and 25 \leq H m \leq 70 ; \qquad ( 1 )$$
$$5 < Da \leq 10 , 5 \leq A \leq 40 , and 27 \leq H m \leq 80 ; or \qquad ( 2 )$$
$$1 \leq Da \leq 5 , 5 \leq A \leq 20 , and 35 \leq H m \leq 80 . \qquad ( 3 )$$

6. The electrode assembly according to claim 1, wherein a sphericity of the silicon material particles is S, and 0.7≤S≤1.

7. The electrode assembly according to claim 1, wherein
the flat portion has a first thickness L1 in a first direction;
the two corner portions are respectively provided at two opposite ends of the flat portion in a second direction perpendicular to the first direction, and the two corner portions have a second thickness L2 in the second direction;
each turn of the electrode plate comprises two flat segments oppositely disposed along the first direction and two corner segments respectively provided at two ends of the flat segment along the second direction; and
the electrode plate has a tail end at a flat segment of an outermost turn of the electrode plate; all the flat segments and the tail end stacked in the first direction form the flat portion; the first thickness L1 is a thickness of the flat portion in the first direction, including the tail end; all the corner segments located on a same side of the flat segments in the second direction form the corner portion; the second thickness L2 is a thickness of the corner portion in the second direction passing through a midpoint of a line connecting two ends of an innermost corner segment; and the electrode assembly satisfies one of the following conditions:
(1) a winding turn number of the electrode plate of the electrode body is an even number, and L1 and L2 satisfy: 2.0≤L1/L2≤2.2; or
(2) a winding turn number of the electrode plate of the electrode body is an odd number, and L1 and L2 satisfy: 2.0≤L1/L2≤2.4.

8. The electrode assembly according to claim 1, wherein the negative electrode active material layer comprises a negative electrode active material, and the negative electrode active material comprises the silicon material particles; and
the negative electrode active material further comprises at least one of silicon carbide, silicon oxide, graphite, or hard carbon.

9. The electrode assembly according to claim 7, wherein the negative electrode active material comprises graphite, a gram capacity of graphite is ρ (mAh/g), 350≤ρ≤370, and an OI value of graphite satisfies: 6≤OI≤18.

10. The electrode assembly according to claim 1, wherein the positive electrode plate comprises the positive electrode active material layer, and the positive electrode active material layer comprises a positive electrode binder; and
based on a total weight of the positive electrode active material layer, a weight percentage of the positive electrode binder is B, and 0.2%≤B≤2.4%.

11. A battery, comprising:
a housing; and
an electrode assembly, wherein the electrode assembly is provided in an internal space of the housing;
the electrode assembly comprises a positive electrode plate, a negative electrode plate, and a separator disposed between the positive electrode plate and the negative electrode plate; wherein the positive electrode plate, the negative electrode plate, and the separator are wound for multiple turns to form the electrode assembly body, and the electrode body comprises a flat portion and corner portions provided at two opposite ends of the flat portion, the corner portions refer to the curved portions in the electrode body;
the corner portions of the positive electrode plate are provided with a plurality of first protrusions, and along a thickness direction of the positive electrode plate, a height of the first protrusions is Hm (μm), wherein 15≤Hm≤80; and
the negative electrode plate comprises a negative electrode active material layer, the negative electrode active material layer comprises silicon material particles; and based on a total weight of the negative electrode active material layer, a weight percentage of the silicon material particles is A (%), wherein 5≤A≤50; and an average particle diameter Da (μm) of the silicon material particles satisfies: 1≤Da≤30.

12. The battery according to claim 11, wherein 5≤A≤20.

13. The battery according to claim 11, wherein the positive electrode plate comprises a positive electrode current collector and a positive electrode active material layer provided on a surface of the positive electrode current collector, a coating weight per unit area of the positive electrode active material layer is CW1 (mg/1540.25 mm²), and 150≤CW1≤400.

14. The battery according to claim 13, wherein 150≤CW1≤250, and the negative electrode plate satisfies one of the following conditions:
$$10 < D a \leq 20 , 5 \leq A \leq 50 , and 15 \leq H m \leq 60 ; \qquad ( 1 )$$
$$5 < Da \leq 10 , 5 \leq A \leq 40 , and 17 \leq H m \leq 80 ; or \qquad ( 2 )$$
$$1 \leq Da \leq 5 , 5 \leq A \leq 23 , and 25 \leq H m \leq 80 . \qquad ( 3 )$$

15. The battery according to claim 13, wherein 250≤CW1≤400, and the negative electrode plate satisfies one of the following conditions:
$$10 < D a \leq 20 , 5 \leq A \leq 50 , and 25 \leq H m \leq 70 ; \qquad ( 1 )$$
$$5 < Da \leq 10 , 5 \leq A \leq 40 , and 27 \leq H m \leq 80 ; or \qquad ( 2 )$$
$$1 \leq Da \leq 5 , 5 \leq A \leq 20 , and 35 \leq H m \leq 80 . \qquad ( 3 )$$

16. The battery according to claim 11, wherein a sphericity of the silicon material particles is S, and 0.7≤S≤1.

17. The battery according to claim 11, wherein the flat portion has a first thickness L1 in a first direction, and the first direction is the thickness direction of the electrode assembly;
the two corner portions are respectively provided at two opposite ends of the flat portion in a second direction perpendicular to the first direction, and the two corner portions have a second thickness L2 in the second direction;
each turn of the electrode plate comprises two flat segments oppositely disposed along the first direction and two corner segments respectively provided at two ends of the flat segment along the second direction; and
the electrode plate has a tail end at a flat segment of an outermost turn of the electrode plate; all the flat segments and the tail end stacked in the first direction form the flat portion; the first thickness L1 is a thickness of the flat portion in the first direction, including the tail end; all the corner segments located on a same side of the flat segments in the second direction form the corner portion; the second thickness L2 is a thickness of the corner portion in the second direction passing through a midpoint of a line connecting two ends of an innermost corner segment; and the electrode assembly satisfies one of the following conditions:
(1) a winding turn number of the electrode plate of the electrode body is an even number, and L1 and L2 satisfy: 2.0≤L1/L2≤2.2; or
(2) a winding turn number of the electrode plate of the electrode body is an odd number, and L1 and L2 satisfy: 2.0≤L1/L2≤2.4.

18. The battery according to claim 11, wherein the negative electrode active material layer comprises a negative electrode active material, and the negative electrode active material comprises the silicon material particles; and
the negative electrode active material further comprises at least one of silicon carbide, silicon oxide, graphite, or hard carbon.

19. The battery according to claim 17, wherein the negative electrode active material comprises graphite, a gram capacity of graphite is ρ (mAh/g), 350≤ρ≤370, and an OI value of graphite satisfies: 6≤OI≤18.

20. The battery according to claim 11, wherein the positive electrode plate comprises the positive electrode active material layer, and the positive electrode active material layer comprises a positive electrode binder; and
based on a total weight of the positive electrode active material layer, a weight percentage of the positive electrode binder is B, and 0.2%≤B≤2.4%.
